(19) United States
(12) Patent Application Publication
(10) Pub. No.: US 2009/0033727 A1
(43) Pub. Date: Feb. 5, 2009

(54) LATERAL FLOW DEVICE PRINTHEAD WITH INTERNAL GUTTER

(76) Inventors: Constantine N. Anagnostopoulos, Mendon, NY (US); Hrishikesh V. Panchawagh, Rochester, NY (US)

Correspondence Address: David A. Novais;Patent Legal Staff, Eastman Kodak Company, 343 State Street, Rochester, NY, 14650-2201, US

(21) Appl. No.: 11/831,043

(22) Filed: Jul. 31, 2007

(51) Int. Cl. B41J 2/185

(52) U.S. Cl. 347/90

(57) ABSTRACT

The invention provides an inkjet printhead comprising a lateral flow device nozzle plate, at least one ink nozzle in said plate, and an integral superstructure, containing a gutter, integral to said nozzle plate. A method of using the inkjet printhead is also disclosed.

### FIELD OF THE INVENTION

This invention relates generally to the field of inkjet printing devices, and in particular to liquid ink printheads which integrate multiple nozzles on a single substrate and in which the liquid drop is selected for printing by electromechanical means.

### BACKGROUND OF THE INVENTION

Inkjet printing has become recognized as a prominent contender in the digitally controlled, electronic printing areas because, e.g., of its non-impact, low noise characteristics and system simplicity. For these reasons, Inkjet printers have achieved commercial success for home and office use and other areas. Inkjet printing mechanisms can be categorized as either continuous (CIJ) or Drop-on-Demand (DOD). U.S. Pat. No. 3,946,398, which issued to Kyser et al. in 1970, discloses a DOD Inkjet printer which applies a high voltage to a piezoelectric crystal, causing the crystal to bend, applying pressure on an ink reservoir and jetting drops on demand. Piezoelectric DOD printers have achieved commercial success at image resolutions greater than 720 dpi for home and office printers. However, piezoelectric printing mechanisms usually require complex high voltage drive circuitry and bulky piezoelectric crystal arrays, which are disadvantageous in regard to number of nozzles per unit length of printhead, as well as the length of the printhead. Typically, piezoelectric printheads contain at most a few hundred nozzles.

Great Britain Patent No. 2,007,162, which issued to Endo et al., in 1979, discloses an electrothermal drop-on-demand Inkjet printer that applies a power pulse to a heater which is in thermal contact with water based ink in a nozzle. A small quantity of ink rapidly evaporates, forming a bubble, which causes a drop of ink to be ejected from small apertures along an edge of a heater substrate. This technology is known as thermal Inkjet or bubble jet.

Thermal Inkjet printing typically requires that the heater generates an energy impulse enough to heat the ink to a temperature near 400° C. which causes a rapid formation of a bubble. The high temperatures needed with this device necessitate the use of special inks, complicates driver electronics, and precipitates deterioration of heater elements through cavitation and kogation. Kogation is the accumulation of ink combustion by-products that encrust the heater with debris. Such encrusted debris interferes with the thermal efficiency of the heater and thus, shorten the operational life of the printhead. And, the high active power consumption of each heater prevents the manufacture of low cost, high speed and page wide printheads.

Continuous Inkjet printing itself dates back to at least 1929. See U.S. Pat. No. 1,941,001 which issued to Hansell that year.

U.S. Pat. No. 3,373,437 which issued to Sweet et al. in March 1968, discloses an array of continuous Inkjet nozzles wherein ink drops to be printed are selectively charged and deflected towards the recording medium. This technique is known as binary deflection continuous Inkjet printing, and is used by several manufacturers, including Elmjet and Scitex.

U.S. Pat. No. 3,416,153, issued to Hertz et al. in December 1968. This patent discloses a method of achieving variable optical density of printed spots, in continuous Inkjet printing. The electrostatic dispersion of a charged drop stream serves to modulate the number of droplets which pass-through a small aperture. This technique is used in Inkjet printers manufactured by Iris.

U.S. Pat. No. 4,346,387, entitled METHOD AND APPARATUS FOR CONTROLLING THE ELECTRIC CHARGE ON DROPLETS AND INKJET RECORDER INCORPORATING THE SAME issued in the name of Carl H. Hertz on Aug. 24, 1982. This patent discloses a CIJ system for controlling the electrostatic charge on droplets. The droplets are formed by breaking up of a pressurized liquid stream, at a drop formation point located within an electrostatic charging tunnel, having an electrical field. Drop formation is effected at a point in the electrical field corresponding to whatever predetermined charge is desired. In addition to charging tunnels, deflection plates are used to actually deflect the drops. The Hertz system requires that the droplets produced be charged and then deflected into a gutter or onto the printing medium. The charging and deflection mechanisms are bulky and severely limit the number of nozzles per printhead.

These conventional continuous Inkjet techniques utilize, in one form or another, electrostatic charging tunnels that are placed close to the point where the drops are formed in the stream. In the tunnels, individual drops are charged selectively. The selected drops are charged and deflected downstream by the presence of deflector plates that have a large potential difference between them. A gutter (sometimes referred to as a “catcher”) is normally used to intercept the charged drops and establish a non-print mode, while the uncharged drops are free to strike the recording medium in a print mode as the ink stream is thereby deflected, between the “non-print” mode and the “print” mode.

Recently, a novel continuous Inkjet printer system has been developed which renders the above-described electrostatic charging tunnels unnecessary. Additionally, it serves to better couple the functions of (1) droplet formation and (2) droplet deflection. That system is disclosed in the commonly assigned U.S. Pat. No. 6,079,821 entitled CONTINUOUS INKJET PRINTER WITH ASYMMETRIC HEATING DROP DEFLECTION filed in the names of James Chwalek, Dave Jeanmaire and Constantine Anagnostopoulos, the contents of which are incorporated herein by reference. This patent discloses an apparatus for controlling ink in a continuous Inkjet printer. The apparatus comprises an ink delivery channel, a source of pressured ink in communication with the ink delivery channel, and a nozzle having a bore which opens into the ink delivery channel, from which a continuous stream of ink flows. Periodic application of weak heat pulses to the stream by a heater causes the ink stream to break up into a plurality of droplets synchronously with the applied heat pulses and at a position spaced from the nozzle. The droplets are deflected by increased heat pulses from the heater (in the nozzle bore) which heater has a selectively actuated section, i.e., the section associated with only a portion of the nozzle bore. Selective actuation of a particular heater section, constitutes what has been termed an asymmetrical application of heat to the stream. Alternating the sections can, in turn, alternate the direction in which this asymmetrical heat is supplied and serves to thereby deflect ink drops, inter alia, between a “print” direction (onto a recording medium) and a “non-print” direction (back into a “catcher”). The patent of Chwalek et al. thus provides a liquid printing system that affords significant improvements toward overcoming the prior art problems associated with the number of nozzles per printhead, printhead length, power usage and characteristics of useful inks.

Asymmetrically applied heat results in jet deflection, the magnitude of which depends upon several factors, e.g. the geometric and thermal properties of the nozzles, the quantity of applied heat, the pressure applied to, and the physical, chemical and thermal properties of the ink. Although solvent-based (particularly alcohol-based) inks have quite good deflection patterns, and achieve high image quality in asymmetrically heated continuous Inkjet printers, water-based inks are more problematic. The water-based inks do not deflect as much, thus their operation is not robust. In order to improve the magnitude of the ink droplet deflection within continuous Inkjet asymmetrically heated printing systems there is disclosed in commonly assigned U.S. application Ser. No. 09/470,638 filed Dec. 22, 1999 in the names of Delametter et al. a continuous Inkjet printer having improved ink drop deflection, particularly for aqueous based inks, by providing enhanced lateral flow characteristics, by geometric obstruction within the ink delivery channel.

The invention to be described herein builds upon the work of Chwalek et al. and Delametter et al. in terms of constructing continuous Inkjet printheads that are suitable for low-cost manufacture and preferably for printheads that can be made page wide.

Although the invention may be used with Inkjet printheads that are not considered to be page wide printheads there remains a widely recognized need for improved Inkjet printing systems, providing advantages for example, as to cost, size, speed, quality, reliability, small nozzle orifice size, small droplets size, low power usage, simplicity of construction in operation, durability and manufacturability. In this regard, there is a particular long-standing need for the capability to manufacture page wide, high resolution Inkjet printheads. As used herein, the term “page wide” refers to printheads of a minimum length of about four inches. High-resolution implies nozzle density, for each ink color, of a minimum of about 300 nozzles per inch to a maximum of about 2400 nozzles per inch.

To take full advantage of page wide printheads with regard to increased printing speed they must contain a large number of nozzles. For example, a conventional scanning type printhead may have only a few hundred nozzles per ink color. A four inch page wide printhead, suitable for the printing of photographs, should have a few thousand nozzles. While a scanned printhead is slowed down by the need for mechanically moving it across the page, a page wide printhead is stationary and paper moves past it. The image can theoretically be printed in a single pass, thus substantially increasing the printing speed.

There are two major difficulties in realizing page wide and high productivity Inkjet printheads. The first is that nozzles have to be spaced closely together, of the order of 10 to 80 micrometers, center to center spacing. The second is that the drivers providing the power to the heaters and the electronics controlling each nozzle must be integrated with each nozzle, since attempting to make thousands of bonds or other types of connections to external circuits is presently impractical.

One way of meeting these challenges is to build the printheads on silicon wafers utilizing VLSI technology and to integrate the CMOS circuits on the same silicon substrate with the nozzles.

While a custom process, as proposed in the patent to Silverbrook, U.S. Pat. No. 5,880,759 can be developed to fabricate the printheads, from a cost and manufacturability point of view it is preferable to first fabricate the circuits using a nearly standard CMOS process in a conventional VLSI facility. Then, to post process the wafers in a separate MEMS (micro-electromechanical systems) facility for the fabrication of the nozzles and ink channels.

U.S. Pat. No. 6,439,703—Anagnostopoulos discloses a continuous Inkjet printhead having a plurality of nozzles, the printhead comprising: a silicon substrate including integrated circuits formed therein for controlling operation of the printhead, the silicon substrate having an ink channel formed therein; an insulating layer or layers overlying the silicon substrate, the insulating layer or layers having a bore formed therein and communicating with the ink channel; and wherein the silicon substrate includes at each nozzle a blocking structure formed of silicon, silicon dioxide or other materials or combinations of film layers between the ink channel and the bore, an access opening being provided between the ink channel and the bore to permit ink from the ink channel to flow about the blocking structure and to enter the access opening at a location offset from the bore to provide lateral flow components to the liquid ink entering the bore.

U.S. Pat. No. 6,439,703—Anagnostopoulos also discloses a method of operating a continuous Inkjet printhead comprising: providing liquid ink under pressure in a channel formed in a silicon substrate having a series of integrated circuits formed therein for controlling operation of the printhead; causing the ink to flow into a bore formed in an insulating layer or layers overlying the silicon substrate, asymmetrically heating of the ink flowing around a heater element to control the direction of an ink droplet; and providing lateral flow components to an Inkjet or stream that is established by having ink flow about a blocking structure formed in the silicon substrate just below the bore.

U.S. Pat. No. 6,439,703—Anagnostopoulos further discloses a method of forming a continuous Inkjet printhead comprising: providing a silicon substrate having integrated circuits for controlling operation of the printhead, the silicon substrate having an insulating layer or layers formed thereon, the insulating layer or layers having electrical conductors formed therein that are electrically connected to circuits formed in the silicon substrate; forming in the insulating layer or layers a bore; forming in the silicon substrate an ink channel that is to communicate with the bore; and forming a blocking structure in the silicon substrate for controlling lateral flow of ink from the ink channel formed in the silicon substrate to the bore formed in the insulating layer or layers.

There remains a need for an improved lateral flow printhead for continuous inkjet printing which is compact, which prevents the recirculated ink from coming into contact with ambient air, and which provides for higher image quality and high printing speed.

### SUMMARY OF THE INVENTION

The invention relates to an inkjet printhead comprising a lateral flow nozzle plate, at least one ink nozzle in said plate, and a superstructure containing a gutter. A method of using the inkjet printhead is also disclosed.

### BRIEF DESCRIPTION OF THE DRAWINGS

FIG. 1 is a schematic cross-section of a printhead in accordance with a preferred embodiment of the invention.

FIG. 2 is a schematic cross-section of a printhead in accordance with another embodiment of this invention.

FIGS. 3A-3I illustrate forming a printhead superstructure from silicon wafers.

### DETAILED DESCRIPTION OF THE INVENTION

The invention has numerous advantages over prior printheads in the continuous inkjet art. The utilization of a lateral flow device printer with an integral gutter superstructure creates a structure that has improved print quality as the nozzle of the inkjet is closer to the paper moving under the inkjet head. Since the only air entering the printhead is the well-controlled collinear air and since the drops travel mostly in an enclosed structure the print drops are not subjected to uncontrolled air currents thus resulting in better drop placement accuracy. Also, the closeness of the exit from the inkjet nozzles onto the paper allows for less deviation of the drops prior to their reaching the paper thereby creating a better image. These and other advantages will be apparent from the description below.

The lateral flow nozzle architecture is well known and illustrated by several patents including U.S. Pat. No. 6,382,782—Anagnostopoulos et al hereby incorporated by reference. Other patents illustrating the lateral flow inkjet are U.S. Pat. No. 6,497,510—Delametter et al. and U.S. Pat. No. 6,439,703 Anagnostopoulos et al. In the lateral flow inkjet the streams of print and non print drops are separated by the response to differential heating in the nozzle plate. The angle of separation between print drops and non print drops in a lateral separation nozzle is only a few degrees. Therefore, it is desirable to have a very accurate alignment between the nozzle array and the edge of the gutter as well as good control of the gutter edge, especially for long printheads. It has been found that the formation of the superstructure below and around the nozzle whether it is made from a single member, or multiple aligned and bonded silicon wafers, allows for the desired accuracy. As used herein, superstructure means the part of the printhead located below and around the nozzle.

The superstructure of the invention permits a shorter time and distance for drop separation because it is accurately formed and accurately aligned and bonded to the nozzle plate. The preferred superstructure is formed from wafers of silicon that have been etched and bonded together to form an integral superstructure. The superstructure channel for carrying collinear air and guttering of non-selected small drops is preferably between 2 and 3 mm thick. This allows the print drops to reach the paper, typically about 1 mm below the bottom edge of the superstructure, after a travel distance of only about 3 mm to 4 mm from the nozzle. A short distance from nozzle to paper allows less distance for the drops to become misdirected and not hit the proper spot on the paper.

Apart from the advantages described above, the integral superstructure prevents the relatively dirty ambient air from coming into contact with the surface of the nozzleplate and the exit orifices themselves, which could cause jet misdirection. Additionally, it provides for a controlled atmosphere around the nozzles at all times as well as the option of introducing and withdrawing through the collinear air channels and the nozzles, solvents or other cleaning fluids for the purpose of cleaning in and around the exit orifices. Furthermore, in case UV inks are used, the superstructure can provide a light shield so ink in and around each exit orifice is not exposed to stray UV curing light which would harden the ink and result in a fully or partially plugged nozzle.

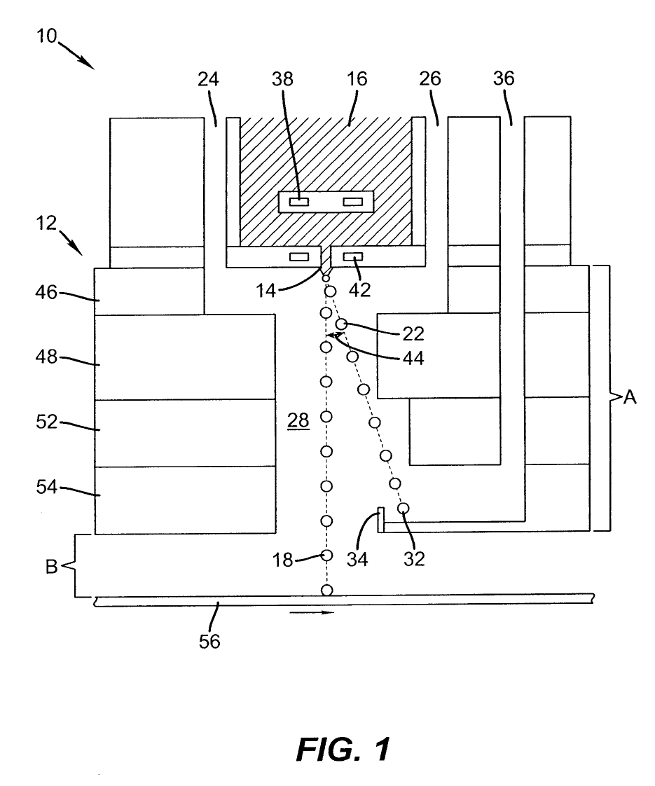

FIG. 1 is an illustration of a printhead having a superstructure 12 in accordance with the invention. The lateral flow device consists of a nozzle array 14 emitting droplets of ink 16 and 18. Each nozzle of nozzle array 14 emits a print drop stream 18 and a non print drop stream 22. Channels 24 and 26 deliver air into the collinear air channel 28. The non print drops enter gutter 32 behind knife edge wall 34. The ink recovered from the non print drops is returned through channel 36 for recycling in a known manner. The lateral flow nozzle arrangement has two sets of heaters 38 and 42. The action of these heaters operating in the known manner, such as illustrated in U.S. Pat. No. 6,382,782, enables the direction of the emission of print drops to be different than the non print drops. The angle 44 between the print drop stream 18 and non print drop stream 22 is relatively small, typically between 2° and 3° at high operating frequencies. Therefore, while the illustration is not to scale, it is apparent that the two streams of drops will have a limited divergence in the superstructure 12 as the angle 44 of stream division is narrow so that placement accuracy of the gutter for non print drops and outlet for print drops is of great importance. The superstructure 12 as measured at “A” is between 2 and 3 mm in height. As illustrated in FIG. 1 there are four layers 46, 48, 52, and 54. The distance “B” from the superstructure 12 to the paper 56 is between 0.5 and 1.5 mm. This short distance between the nozzle 14 and the paper 56 allows less time for the drops to be misdirected by the air streams or, the failure to leave the nozzle at the correct angle 44, to cause incorrect placement of the print drops on the paper. Further, since the drops while inside the superstructure are protected from uncontrolled air currents, their directionality and eventual placement accuracy on the paper are well maintained.

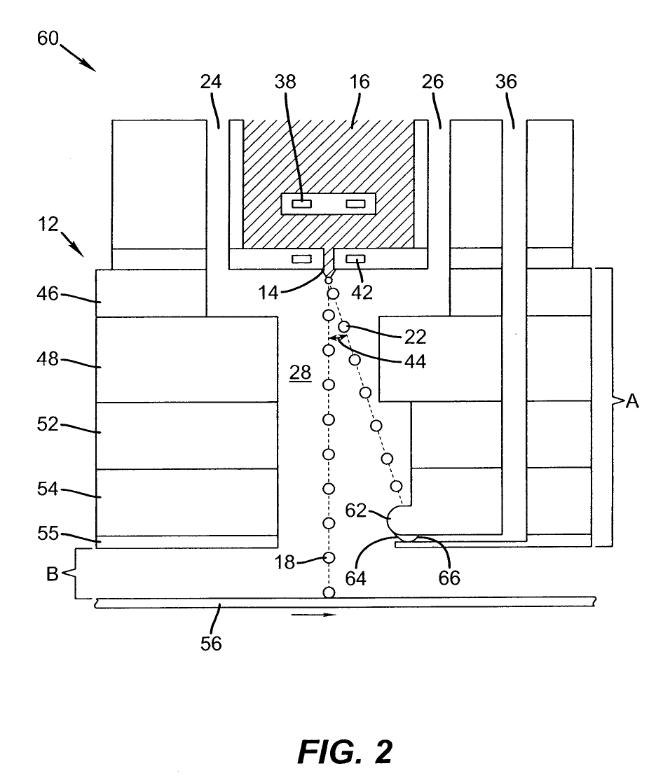

In FIG. 2 is another embodiment of a lateral flow printhead with a superstructure of the invention. The printhead 60 is illustrated with like numbers as in FIG. 1 for the same structures. The printhead 60 is provided with Coanda gutter 62. The no print droplets 22 are directed to impact on the Coanda gutter 62 and run down from gutter 62 to the withdrawal channel 36 where suction and capillary action withdraws the non print drop ink 22 for recycling. The no print droplet ink runs to the bottom of the gutter at 64 where it enters the channel and forms meniscus 66 and is withdrawn by suction and capillary action in channel 36. This structure is considered less preferred as it is difficult to form rounded edges by silicon etching. As the layer of wafer 55 is thin the distances of 0.5 to 1.5 mm for the B distance and the 2-3mm distance for “A” are not significantly affected by use of the Coanda gutter.

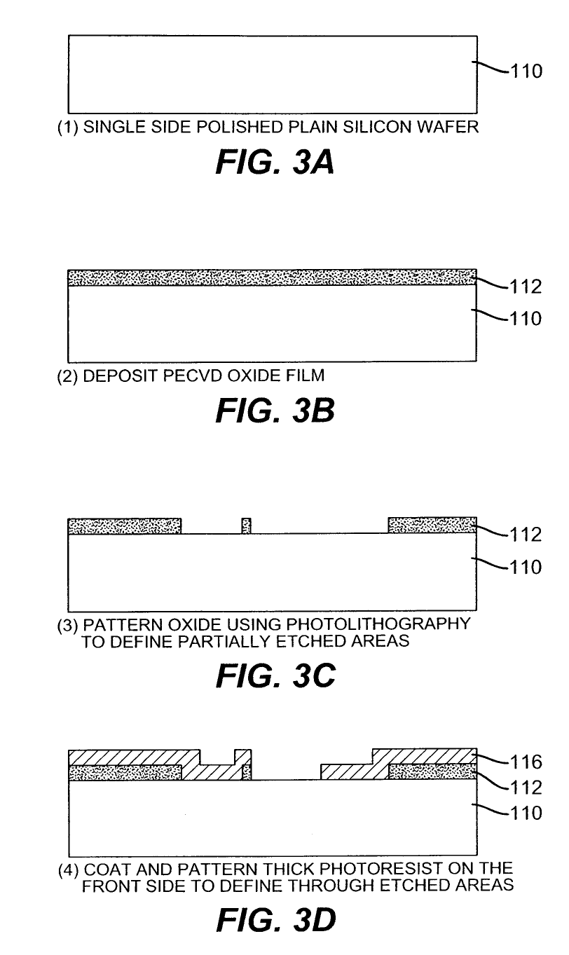

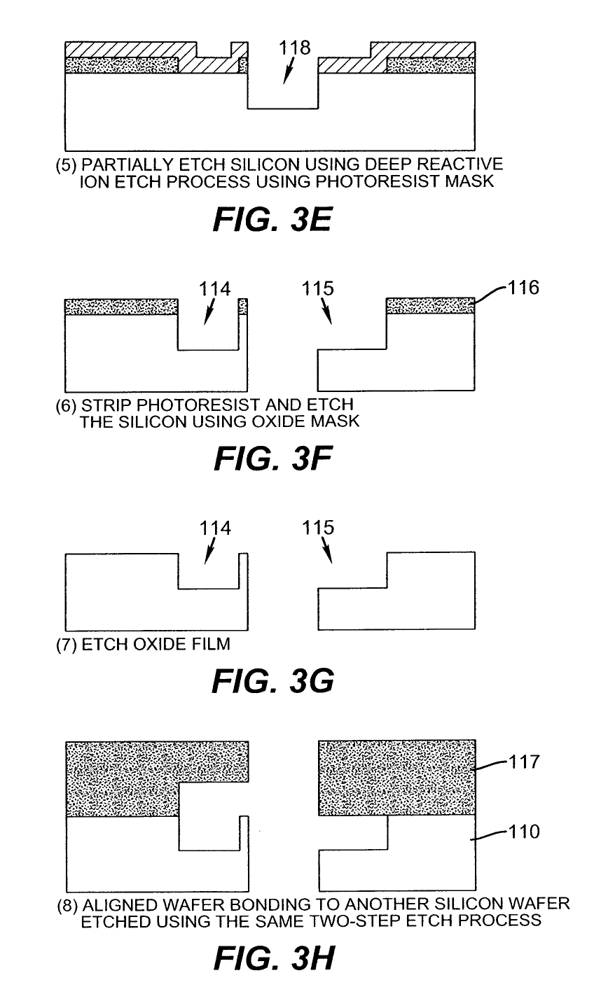

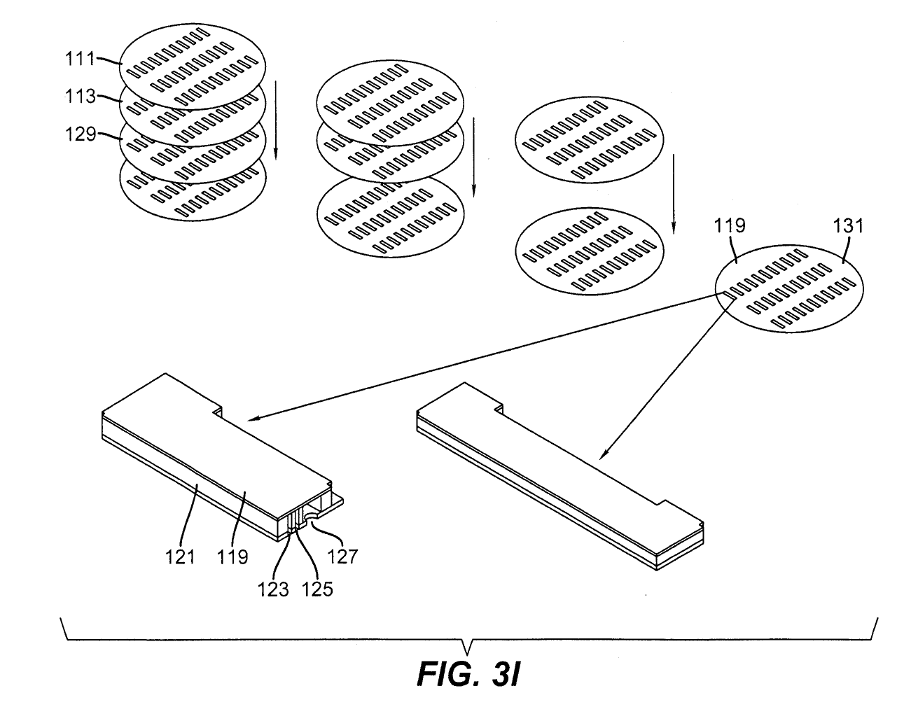

The printhead of the invention may be formed by any of the known techniques for shaping silicon articles. These include CMOS circuit fabrication techniques, microelectrical mechanical structure fabrication techniques (MEMS) and others. The preferred technique has been found to be the deep reactive ion etch (DRIE) process. Compared to other silicon fabrication techniques, this process is preferred because it enables fabrication of high aspect ratio structures with large etch depths (>10 micrometers) as is required for this device. The techniques for creation of silicon integral structures that include the nozzle plates and gutters, involving etching several silicon wafers which are then assembled in an extremely accurate manner, is particularly desirable for fabricating multiple nozzle arrays continuous inkjet (CIJ) printheads that are accurately aligned to each other. The methods and apparatus for etching, bonding and aligning silicon wafers are well-known. In FIGS. 3A-3I there is given a brief illustration of the manufacturing process. In FIG. 3A there is shown a single wafer 110 that has no features etched into the silicon. In FIG. 3B a layer of plasma enhanced chemical vapor deposited (PECVD) silicon dioxide film 112 has been deposited on the wafer. In FIG. 3C the oxide layer has been patterned using photolithography to define partially etched areas. In FIG. 3D the surface has been coated with photoresist 116 on the side to be etched and patterned to define the opening in the photoresist where etching is to take place. In FIG. 3E the wafer 110 has been partially etched utilizing deep reactive ion etch process using the photoresist mask. In FIG. 3F after further etching has been carried out using the oxide hard mask, there is formed a hole 115 through the wafer as well as removed part of the wafer at 114. In FIG. 3G the oxide film has been removed to recover a formed wafer that will be one layer of the superstructure. In FIG. 3H another wafer 117 is bonded to wafer 110. Silicon wafer 117 has already been etched by the same process. In FIG. 3I there is a prospective expanded view of the fabrication of the printhead of this invention via wafer scale integration. As illustrated there are etched wafers 111, 113, and 129 and nozzle plate wafer 130 that are assembled to form wafer stack 117 that is a structure wherein openings have been formed by the individual etchings in the separate wafers 111, 113, and 129. This assembly contains a multitude of identical lateral flow device nozzle arrays each with its own integral gutter. Diced individual devices 128 are then fastened to manifold 121 to form a printhead 119. It can be seen that manifold 121 has openings 123 and 125 which would be channels for air in and out to be supplied to the printhead. Opening 127 would be an orifice in the manifold to bring fluids to the manifold or to provide suction for the ink return from the gutter. It is noted that FIG. 6I is only illustrative. The printhead of the invention as shown in FIG. 1 would generally require at least four layers of plates or wafers with etching to form the needed channels for the integral gutter silicon printhead.

The invention has been described in detail with particular reference to certain preferred embodiments thereof, but it will be understood that variations and modifications can be effected within the spirit and scope of the invention.

PARTS LIST

| | |
|---|---|
| 12 | Superstructure |
| 14 | Nozzle array |
| 16 | Droplets of ink |
| 18 | Drop stream |
| 22 | non print droplet steam |
| 28 | Collinear air channel |
| 32 | Gutter |
| 34 | Knife edge |
| 36 | Channel |
| 38 | Heaters |
| 42 | Heaters |
| 44 | Correct angle |
| 46 | One layer |
| 48 | Another layer |
| 52 | Another layer |
| 54 | Another layer |
| 55 | Wafer |
| 56 | Paper |
| 60 | Printhead |
| 62 | Coanda gutter |
| 64 | Gutter bottom |
| 66 | Meniscus |
| 110 | Single wafer |
| 111 | Etched wafer |
| 112 | Silicon dioxide film |
| 113 | Etched wafer |
| 114 | Silicon wafer |
| 115 | Formed hole |
| 116 | Pattern of photoresist |
| 117 | Silicon wafer |
| 119 | Printhead |
| 121 | Manifold |
| 123 | Manifold openings |
| 125 | Openings |
| 127 | Opening |

1. An inkjet printhead comprising a lateral flow device nozzle plate and a superstructure containing a gutter.

2. The inkjet printhead of claim 1 wherein the gutter is a distance between 2 and 3 mm away from the surface of the nozzle plate.

3. The inkjet printhead of claim 1 wherein the superstructure is between 150 and 300 μm in height from the nozzle to the bottom of the ink exit hole.

4. The inkjet printhead of claim 1 wherein the width of the collinear air channel into which the row of nozzles inject ink is between 100 and 1000 micrometers.

5. The inkjet head of claim 1 wherein the superstructure only has openings for collinear air, a channel to remove non-selected ink drops from the gutter, and the exit orifice where selected ink drops exit the printhead.

6. The inkjet head of claim 1 wherein the gutter, the nozzle plate and superstructure are integral to each other.

7. The inkjet head claim 6 wherein the gutter comprises a knife edge or thin wall.

8. The inkjet head of claim 6 wherein the gutter comprises a Coanda gutter.

9. The inkjet head of claim 1 wherein said superstructure comprises silicon wafers etched and then joined together to form an integral structure.

10. A method of printing comprising providing an inkjet printhead comprising a lateral flow nozzle plate, at least one ink nozzle in said plate, and a superstructure containing a gutter integral to the nozzle plate, continuously expelling ink through the at least one ink nozzle, catching non-print selected drops, passing print selected drops through the exit passage of the superstructure, passing paper beneath the exit of the superstructure and bringing said print selected drops into contact with the paper.

11. The method of claim 10 wherein the distance from the surface of the nozzle plate to the paper is less than 15 mm.

12. The method of claim 10 wherein the distance from the surface of the nozzle plate to the paper is more than 2 mm.

13. The method of claim 10 wherein the superstructure is provided with a passageway to bring collinear air into said superstructure.

14. The method of claim 13 wherein the collinear air flow is at a speed of between 5 and 50 meters per second.

15. The method of claim 10 wherein selected drops have a volume of between 0.6 and 16 pico liters.

16. The method of claim 10 wherein the only gas introduced into said superstructure is collinear air flow gas.
